(19) United States
(12) Patent Application Publication
(10) Pub. No.: US 2026/0135726 A1
(43) Pub. Date: May 14, 2026

(54) ADAPTIVE CONTENT PRESENTATION FOR TELECONFERENCES

(71) Applicant: Microsoft Technology Licensing, LLC, Redmond, WA (US)

(72) Inventor: Ryen William WHITE, Woodinville, WA (US)

(73) Assignee: Microsoft Technology Licensing, LLC, Redmond, WA (US)

(21) Appl. No.: 18/947,335

(22) Filed: Nov. 14, 2024

(51) Int. Cl. H04L 12/18; G06F 3/01; G06V 10/70; G06V 30/14

(52) U.S. Cl. CPC H04L 12/1831; G06F 3/013; G06V 10/70; G06V 30/14; H04L 12/1818; H04L 12/1822

(57) ABSTRACT

This document relates to adaptive presentation of content during a teleconference. For instance, the disclosed techniques can employ one or more attention signals to infer that a user's attention is directed to certain content presented during a particular time period during a teleconference. Then, other content that the user may have missed can be summarized using a generative machine learning model. A summary of the potentially-missed content can be output to the user during the teleconference. In this manner, users who may miss presentation of certain content can remain informed during the course of the teleconference.

### BACKGROUND

One important use case for computing devices involves teleconferencing, where users communicate with remote participants via audio and/or video over a network. During a teleconference, information can be shared among participants using a wide range of modalities. For instance, teleconferences can provide audio and/or video streams, chat capabilities, screen-sharing capabilities, and other ways for participants to share information.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for presenting teleconferencing content. One example includes a computer-implemented method that can include accessing multiple teleconferencing data streams relating to a teleconference having multiple participants. The method can also include receiving an attention signal indicating that a particular participant in the teleconference has directed attention to first presented data from a first teleconferencing data stream of the teleconference during a particular time period. The method can also include identifying second presented data that was presented in a second teleconferencing data stream during the particular time period. The method can also include inputting the second presented data to a generative machine learning model with a request to generate a summary of the second presented data. The method can also include receiving a generated summary of the second presented data from the generative machine learning model. The method can also include outputting the generated summary of the second presented data to the particular participant.

Another example entails a system that includes a processor and a storage medium storing instructions. When executed by the processor, the instructions can cause the system to access multiple teleconferencing data streams relating to a teleconference having multiple participants. The instructions can also cause the system to receive an attention signal indicating that a particular participant in the teleconference has directed attention to first presented data from a first teleconferencing data stream of the teleconference during a particular time period. The instructions can also cause the system to identify second presented data that was presented in a second teleconferencing data stream during the particular time period. The instructions can also cause the system to input the second presented data to a generative machine learning model with a request to generate a summary of the second presented data. The instructions can also cause the system to receive a generated summary of the second presented data from the generative machine learning model. The instructions can also cause the system to output the generated summary of the second presented data to the particular participant.

Another example includes a computer-readable storage medium storing executable instructions which, when executed by a processor, cause the processor to perform acts. The acts can include accessing multiple teleconferencing data streams relating to a teleconference having multiple participants. The acts can also include receiving an attention signal indicating that a particular participant in the teleconference has directed attention to first presented data from a first teleconferencing data stream of the teleconference during a particular time period. The acts can also include identifying second presented data that was presented in a second teleconferencing data stream during the particular time period. The acts can also include inputting the second presented data to a generative machine learning model with a request to generate a summary of the second presented data. The acts can also include receiving a generated summary of the second presented data from the generative machine learning model. The acts can also include outputting the generated summary of the second presented data to the particular participant.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example generative language model, consistent with some implementations of the present concepts.

FIG. 2 illustrates an example computer vision model, consistent with some implementations of the present concepts.

FIG. 3 illustrates an example vision language model, consistent with some implementations of the present concepts.

FIG. 4 illustrates an example workflow for adaptive content presentation, consistent with some implementations of the present concepts.

FIG. 5 illustrates an example user interface for a teleconferencing application, consistent with some implementations of the present concepts.

FIG. 6 illustrates a first example where chat content diverges from audio-visual content, consistent with some implementations of the present concepts.

FIGS. 7A and 7B illustrate examples of presenting information relating to divergent content, consistent with some implementations of the present concepts.

FIG. 8 illustrates a second example where chat content diverges from audio-visual content, consistent with some implementations of the present concepts.

FIGS. 9A and 9B illustrate further examples of presenting information relating to divergent content, consistent with some implementations of the present concepts.

FIG. 10 illustrates an example of redirecting user attention from chat content to audio-visual content, consistent with some implementations of the present concepts.

FIG. 11 illustrates an example of a system in which the disclosed implementations can be performed, consistent with some implementations of the present concepts.

FIG. 12 illustrates an example method or technique, consistent with some implementations of the disclosed techniques.

### DETAILED DESCRIPTION

### Overview

As noted above, teleconferencing applications can allow participants to share information using a range of modalities. For instance, a teleconferencing application can provide an audio-visual stream, a chat stream, and/or a shared content stream. In some cases, however, users may not be able to effectively digest information from all of these data streams at once. For instance, one user might be focused intently on a chat discussion with another user while shared content is being presented by a third user, and the users engaged in the chat may miss important points relating to the shared content. Conversely, the user sharing the content may not be focused on the chat discussion and thus may miss out on salient points discussed in the chat.

Furthermore, certain users may have a tendency to focus on a single data stream during a teleconference, whereas other users may tend to monitor multiple data streams concurrently. In fact, some users may not even be aware of their own tendencies for focusing on content presented during online meetings. As a result, different types of users can tend to miss out on digesting different types of information presented during teleconferences.

The disclosed implementations can employ machine learning to adaptively provide targeted content to teleconference participants. For instance, some implementations can employ one or more attention signals to detect that a particular user's attention is directed to a particular data stream for a period of time, which may imply that the user may have missed content presented in another data stream during that time period. Then, a machine learning model can be employed to generate a summary of the missed content, and the summary can be presented to that participant.

In other implementations, users are directed in real-time to focus on a different data stream than the data stream they are currently focused on. This can help prevent users from missing salient content being presented in the other data stream. To determine when to redirect a user's attention to a different data stream, a machine learning model can be employed to detect when salient content is being presented in one data stream and potentially less useful information (e.g., jokes or pleasantries) are being represented in another data stream. In this manner, users can naturally shift their attention to different data streams as they wish, and their attention can be automatically redirected so that they remain informed about important content being presented in other data streams.

### Machine Learning Overview

There are various types of machine learning frameworks that can be trained to perform a given task. Support vector machines, decision trees, Kolmogorov-Arnold networks, state space models, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “teleconferencing data stream,” as used herein, refers to any stream of data communicated among two or more participants in a teleconference. In some cases, different teleconferencing data streams are provided for different teleconferencing modalities, such as audio-visual data, chat data, shared content, etc. The term “attention signal” refers to any signal that can be employed to determine or infer that a user is more likely to be paying attention to one data stream than another data stream at a given time. An attention signal can provide a positive indication of where a user's attention is directed, e.g., a user entering text into a chat data stream using their keyboard suggests that the users' attention is directed toward the chat data stream. An attention signal can also provide a negative indication that a user's attention is not directed to a particular data stream, e.g., if a user has a chat window minimized on their device, this suggests that the user's attention is not directed toward the chat data stream.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-40, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Decoder-Based Generative Language Model

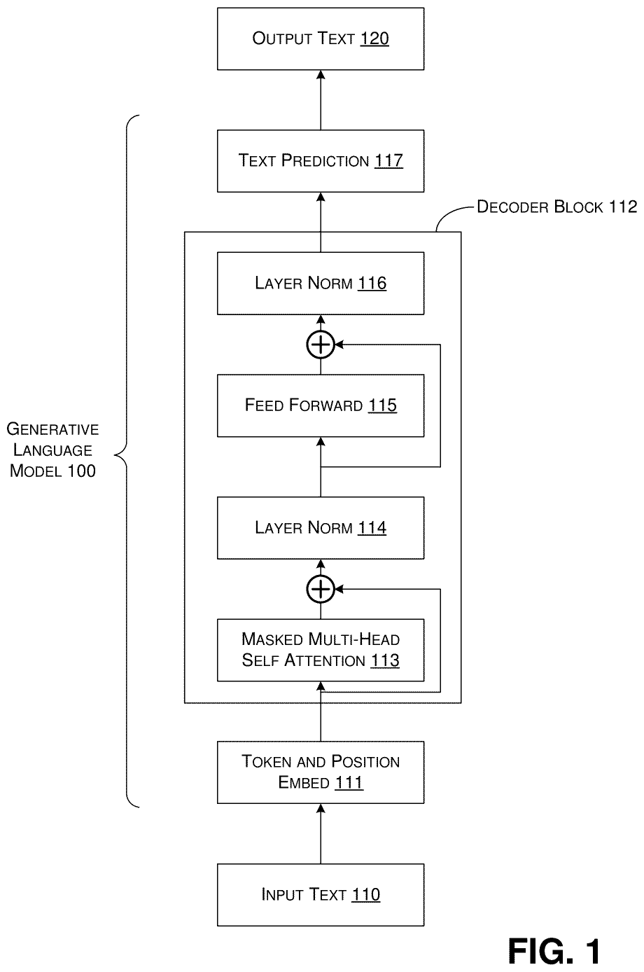

FIG. 1 illustrates an exemplary generative language model 100 (e.g., a transformer-based decoder) that can be employed using the disclosed implementations. Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user or a prompt generated automatically by machine learning using the disclosed techniques. For instance, the input text can include words, sentences, phrases, or other representations of language. The input text can be broken into tokens and mapped to token and position embeddings 111 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 111 are processed in one or more decoder blocks 112. Each decoder block implements masked multi-head self-attention 113, which is a mechanism relating different positions of tokens within the input text to compute the similarities between those tokens. Each token embedding is represented as a weighted sum of other tokens in the input text. Attention is only applied for already-decoded values, and future values are masked. Layer normalization 114 normalizes features to mean values of 0 and variance to 1, resulting in smooth gradients. Feed forward layer 115 transforms these features into a representation suitable for the next iteration of decoding, after which another layer normalization 116 is applied. Multiple instances of decoder blocks can operate sequentially on input text, with each subsequent decoder block operating on the output of a preceding decoder block. After the final decoding block, text prediction layer 117 can predict the next word in the sequence, which is output as output text 120 in response to the input text 110 and also fed back into the language model. The output text can be a newly-generated response to the prompt provided as input text to the generative language model. As discussed more below, in some implementations, the output text can include image generation prompts for completing a three-dimensional virtual space based on one or more input images.

Generative language model 100 can be trained using techniques such as next-token prediction or masked language modeling on a large, diverse corpus of documents. For instance, the text prediction layer 117 can predict the next token in a given document, and parameters of the decoder block 112 and/or text prediction layer can be adjusted when the predicted token is incorrect. In some cases, a generative language model can be pretrained on a large corpus of documents (Radford, et al., “Improving language understanding by generative pre-training,” 2018). In some cases, a generative language model can be trained to predict multiple output tokens in a single inference step (Gloeckle, et al., “Better & faster large language models via multi-token prediction,” Apr. 30, 2024, arXiv preprint arXiv: 2404.19737). After pretraining, generative language model can be tuned using a reinforcement learning technique such as reinforcement learning from human feedback (“RLHF”).

### Example Computer Vision Model

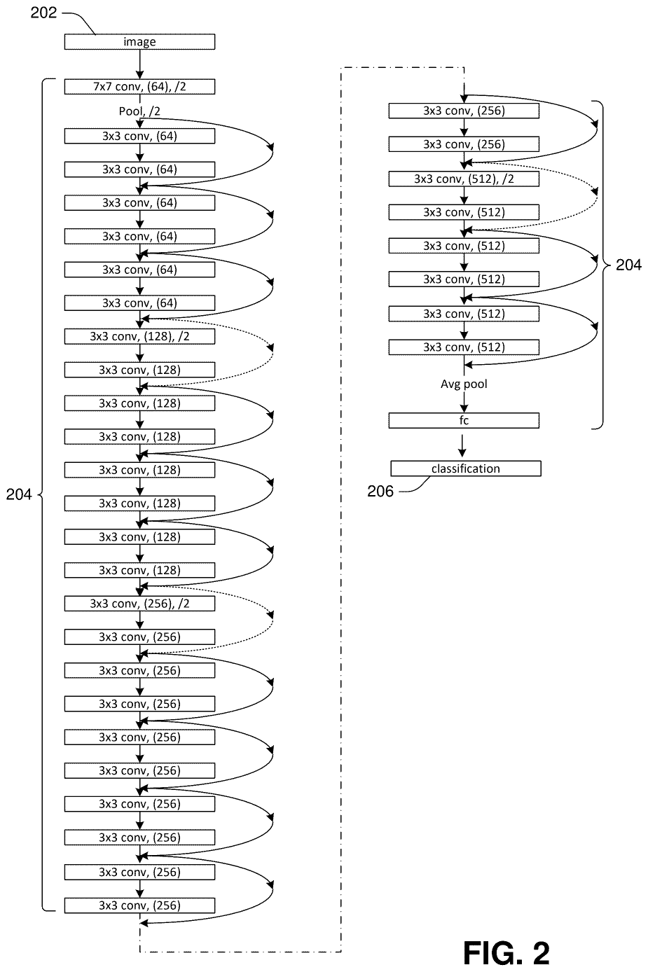

FIG. 2 illustrates a particular example of a neural network model for computer vision. For instance, FIG. 2 shows an image 202 being classified by a computer vision model 204 to determine an image classification 206, where the computer vision model can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters (e.g., 64, 128, 256, 512). If the feature map size is halved by a given convolutional layer (as shown by “/2” in FIG. 2), then the number of filters can be doubled to preserve the time complexity across layers.

After the image has been processed using a series of convolutional layers, the image is processed in a global average pooling layer. The output of the pooling layer is processed with a fully-connected layer with softmax. The fully-connected layer (e.g., one thousand-way) can be used to determine a classification, e.g., an object category of an object in image 202.

The respective layers within computer vision model 204 can have shortcut connections which perform identity operations:

$$y = F ( x , \{ {W}_{i} \} ) + x \qquad ( 1 )$$

where x and y are the input and output vectors of the layers involved and F(x,{Wᵢ}) represents the residual mapping learned by the model. In some connections the dimensions increase across layers (shown as dotted lines in FIG. 2). In these cases, the following projection can be employed to match the dimensions via 1×1 convolutions:

$$y = F ( x , \{ {W}_{i} \} ) + {W}_{s} x \qquad ( 2 )$$

In some implementations, computer vision model 204 can be pretrained on a large dataset of images, such as ImageNet. Such a general-purpose image database can provide a vast number of training examples that allow the model to learn weights that allow generalization across a range of object categories. Said another way, computer vision model 204 can be pretrained in this fashion.

After pretraining, computer vision model 204 can be tuned on another, smaller dataset for categories of interest. For instance, tuning datasets can be provided for specific groups of users. As one example, software developers might tend to use UML (Unified Modeling Language) diagrams or directed acyclic graphs, whereas other users might tend to use conventional flow charts, and thus different computer vision models can be tuned for these different sets of users. As another example, social media users might tend to post images of things in their home, such as pets or furniture, whereas business users might tend to post images of graphs, scatterplots, pie charts, etc.

### Example Vision Language Model

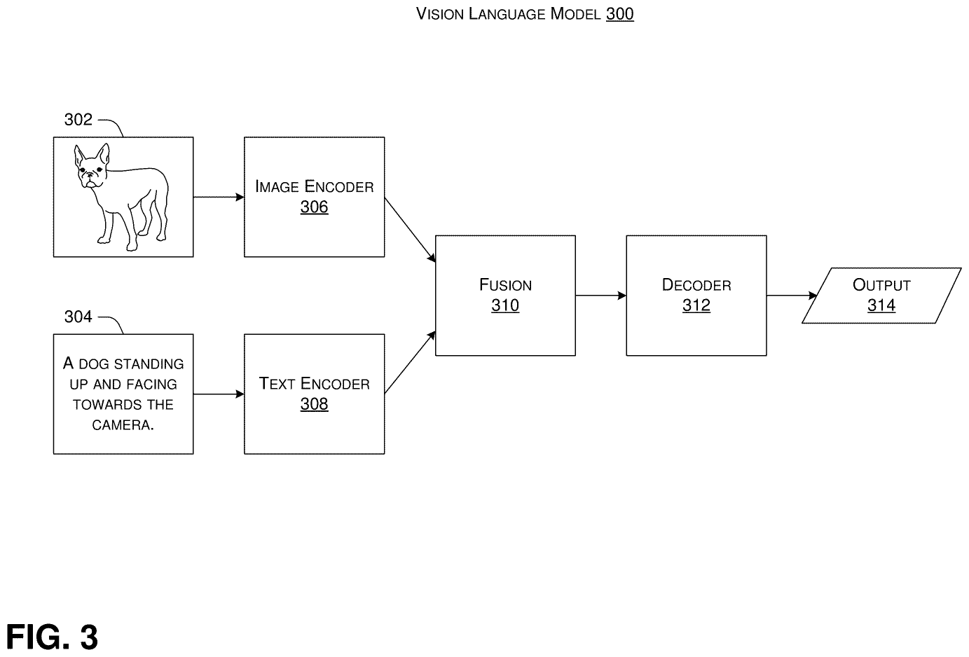

FIG. 3 shows an example vision language model 300 that can process an input image 302 and/or a text input 304. The input image is processed using an image encoder 306 and the text input is processed using a text encoder 308. The image encoder and text encoder produce encodings (e.g., vector embeddings) representing the input image and text input, respectively. A fusion process 310 can fuse the encodings using techniques such as attention, dot product, etc. A decoder 312 can decode the fused encodings to produce an output 314.

In some implementations, the image encoder can also be based on a transformer architecture such as a Vision Transformer (Dosovitskiy, et al., “An image is worth 16×16 words: Transformers for image recognition at scale,” Jun. 3, 2021, arXiv preprint arXiv: 2010.11929v2.) The text encoder 308 can be based on a transformer architecture such as BERT or GPT. In other cases, an “early fusion” approach can employ a shared encoder that processes sequences of text and image tokens using a single encoder that determines embeddings for each text or image token, as in Chameleon. Team C, “Chameleon: Mixed-modal early-fusion foundation models,” 2024, arXiv preprint, arXiv: 2405.09818.

The vision language model 300 can be trained using approaches such as contrastive learning, where the training data includes pairs of text and images and the model is trained to determine whether a given text sample matches a corresponding image sample. In this manner, the image encoder 306 and the text encoder 308 can be trained to generate similar embeddings for text and images that represent similar concepts (e.g., the word “bear” and an image of a bear). Other approaches include masked image modeling and/or masked language modeling and image-text modeling.

The output 314 can characterize an image. For instance, the output can answer a visual question, caption the image, etc. The output can also identify detected objects, classify detected objects, perform image segmentation, etc. As discussed more below, in some cases, the vision language model 300 can determine a label for an object in an input image. The labels can identify a category of the object (e.g., “bed” or “sofa”), a description of the object (e.g., “a queen-sized bed with blue bedding and a headboard”), or even specify information such as a brand of the object (e.g., “ABC brand queen size platform bed”), etc.

### Example Workflow

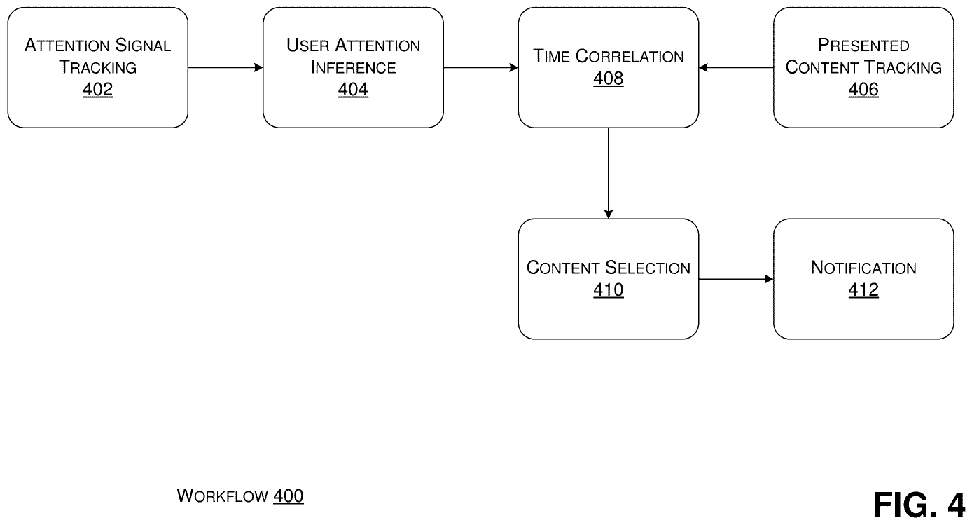

FIG. 4 illustrates a workflow 400 for adaptive presentation of content during a teleconference. Attention signal tracking 402 tracks information related to user interaction with one or more teleconferencing data streams that are presented during a teleconference. For instance, the attention signal tracking can obtain attention signals indicating where the user's gaze is directed, whether the user is entering keystrokes into a chat data stream, whether the user is presenting content in a shared content stream, whether the user is speaking, etc. Additional examples of attention signals that can be tracked are discussed in more detail below.

Based on the attention signals, user attention inference 404 determines which teleconferencing data stream a user is likely paying attention to and/or to which teleconferencing data stream the user is likely not paying attention. For instance, if the user's gaze is directed to shared content for a long period of time, an inference can be made that the user's attention is directed to the shared content stream and not chat or audio-video streams. As another example, if the user frequently enters keystrokes into a chat stream for a period of time, an inference can be made that the user's attention is directed to the chat stream and not to the audio-video stream or shared content streams. Additional examples of how user attention can be inferred from tracked attention signals are discussed in more detail below.

Presented content tracking 406 tracks content presented in different teleconferencing data streams over time. For instance, presented content tracking can employ machine learning to determine the subject matter of a sequence of chat messages, the subject matter of a particular discussion taking place in audio-visual content, the subject matter of content being shared by a particular user, etc.

Next, time correlation 408 correlates time periods where a user's attention is directed to a particular data stream with content presented in that data stream and/or other data streams. For instance, time correlation can determine that one subject was discussed during a chat data stream during a particular time period, while another subject was discussed in an audio-visual data stream during the same (or at least an overlapping) time period.

Content selection 410 selects content to present to a user. For instance, in a scenario where divergent subject matter is discussed in the chat and the audio-video streams during a particular time period, then chat content may be selected to present to a user that was focused on the audio-visual stream during that time period. Likewise, audio-visual content may be selected for another user that was focused on the chat stream during that time period. On the other hand, if similar subject matter is presented in both the chat and audio-visual modalities during that time period, an inference can be made that either modality is sufficient to keep the users informed. Thus, in some implementations, no content is selected to present to the users when similar content is presented in both the teleconferencing data stream that the user was paying attention to and another teleconferencing data stream.

Notification 412 can notify the user of the selected content. For instance, in some cases, a generative machine learning model can be employed to generate a summary of the selected content, and the user is notified of potentially-missed content by outputting the generated summary. In other cases, the selected content is directly extracted from a particular teleconferencing data stream and presented to the user. For instance, in some implementations, the user is presented with a selected subset of earlier chat messages or a clip of previous audio-visual content that the user likely missed. As described more below, the generated summaries and/or extracted data can be presented in any of the teleconferencing data streams. For instance, the generated summaries and/or extracted content can be presented in the teleconferencing data stream to which the user's attention is currently directed, the teleconferencing data stream in which the selected content was originally presented, etc.

In teleconferencing, multiple streams of information arrive at user concurrently. Using workflow 400 as described herein, the disclosed techniques can correlate the content arriving in one stream while the user was focused on another stream and present that missed content to the user, either directly or by summarizing the missed information using machine learning. As described more below, this can enable the disclosed techniques to find missed action items for users, identify answers to questions that were answered previously, identify situations where one teleconferencing data stream provides context for understanding content presented in a different teleconferencing data stream, etc.

### Example Interface

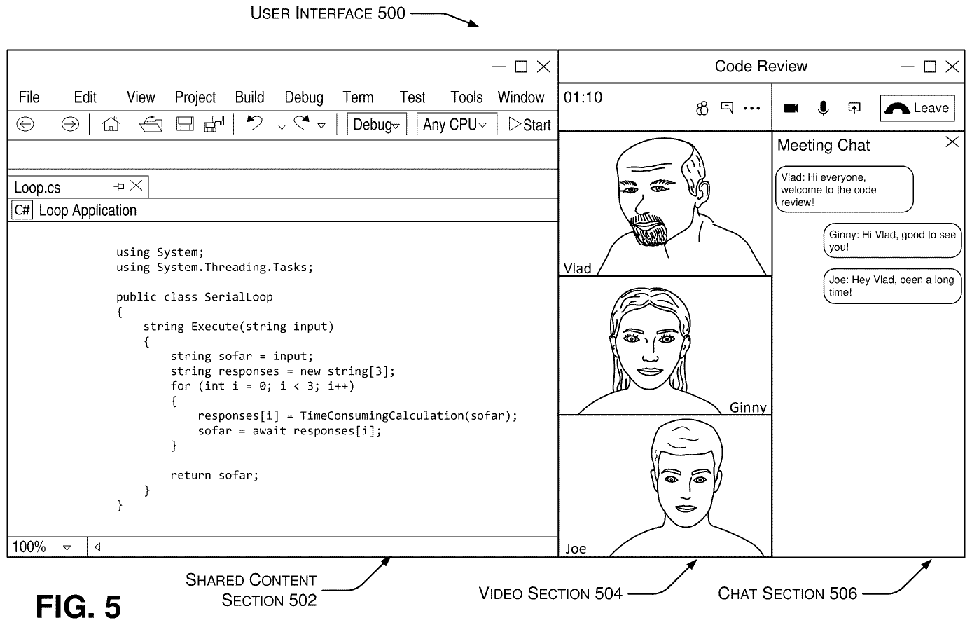

FIG. 5 shows an example user interface 500 having a shared content section 502, a video section 504, and a chat section 506. The shared content section can allow one user to present shared content from their desktop such as a slide deck, word processing files, spreadsheets, integrated development environments, etc. The video section can show a video feed of participants in the teleconference, e.g., obtained from a local camera on the device of that user. The video content can be aligned with an audio stream captured by respective microphones of each of the users. The chat section can enable users to communicate via chat using keystrokes or audio transcription technologies.

FIG. 5 introduces a running example with three users, Vlad, Ginny, and Joe. These three users are doing a code review of code written in C#, which is being presented by Vlad while conducting a teleconference. As shown in FIG. 5, the meeting is just getting started with Vlad, Ginny, and Joe exchanging pleasantries at 01:10 into the meeting.

### First Example Notification

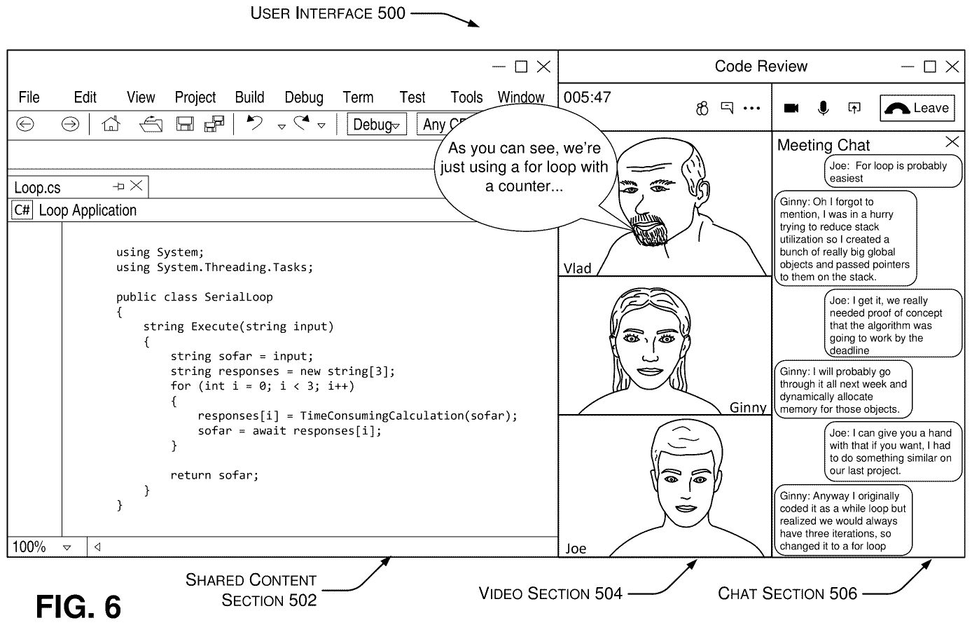

The following illustrates an example where a notification is output to Vlad to summarize chat content between Ginny and Joe that Vlad may have missed while presenting other content. FIG. 6 shows user interface 500 in a scenario where user Vlad is discussing a for loop in the video section 504, and the for loop is shown in shared content section 502. Users Ginny and Joe are initially discussing the for loop in the chat section 506, temporarily switch to discussing a memory utilization issue, and then go back to discussing the for loop. Referring back to FIG. 4, an inference can be made in user attention inference 404 that Vlad's attention is directed to shared content section 502 because he is presenting content in that section to the other users. Conversely, an inference can be made that Ginny and Joe are focusing their attention on the chat section at this time because they are entering keystrokes into the chat.

Presented content tracking 406 can track the content presented in the chat stream by Ginny and Joe and in the audio-visual stream by Vlad. Time correlation 408 can correlate the presented content in different steams to a particular time period(s) during the teleconference. For instance, the time correlation can determine that the chat messages shown in FIG. 6 were entered during the time period when Vlad was discussing the for loop. Content selection 410 can determine that the first and last messages in the chat stream relate to the same subject matter being discussed by Vlad, the for loop, whereas the remaining messages relate to a different topic-memory utilization. In this case, the content selection can select the chat messages relating to memory utilization (but not the for loop) so that Vlad can be notified of the discussion relating to memory utilization.

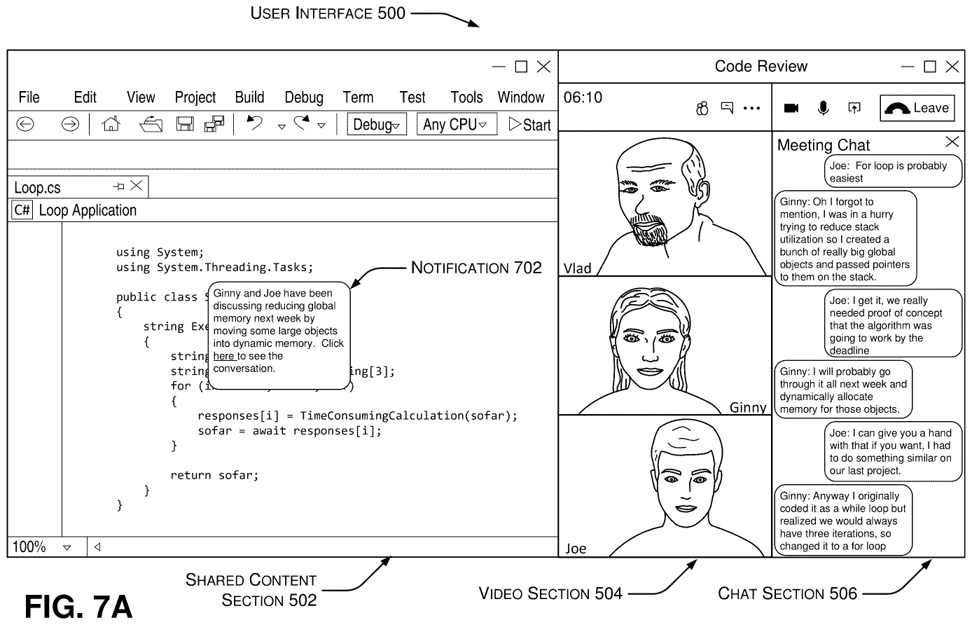

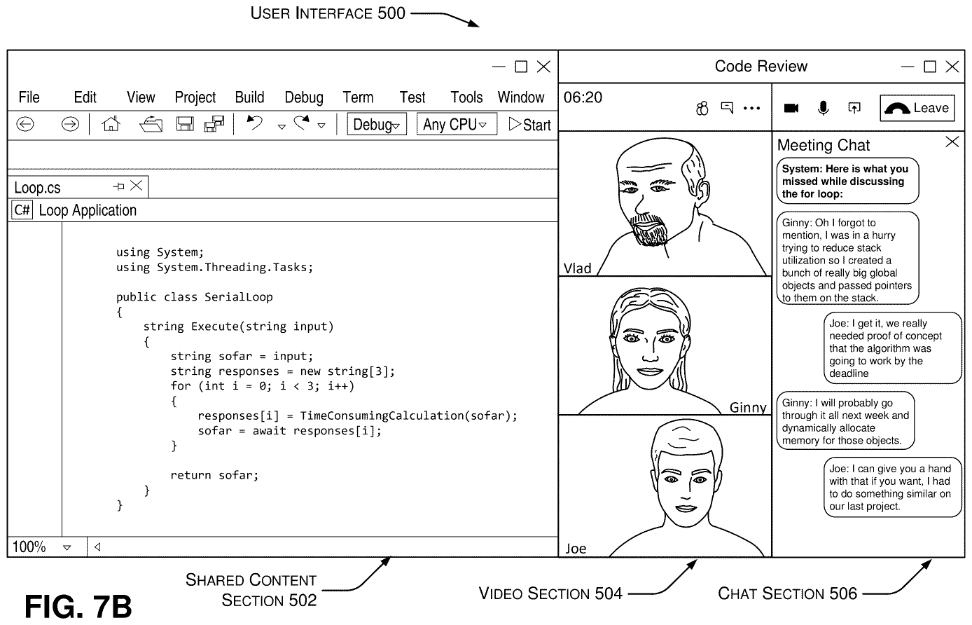

Notification 412 can output a notification to Vlad about the selected content. For instance, FIG. 7A shows a notification 702 where Vlad is notified that Ginny and Joe have been discussing memory utilization in the chat. In some implementations, the notification includes a summary generated by a machine learning model. For instance, the summary can be generated by inputting the selected chat messages (all but the first and last chat messages shown in FIG. 6) into generative language model 100 and requesting that the generative language model summarize the selected chat messages. In FIG. 6, the generated summary states “Ginny and Joe have been discussing reducing global memory next week by moving some large objects into dynamic memory.” The notification 702 also includes a selectable link that allows Vlad to see the selected content itself, e.g., the actual chat messages entered by Ginny and Show. For instance, FIG. 7B shows a scenario where chat section 506 has been updated with retrieved chat content when Vlad selects the link in notification 702. Note that the notification 702 may be output to user interface 500 on Vlad's device but not necessarily on Ginny and Joe's devices, since they convey chat content that Ginny and Joe were presumably paying attention to when they entered the chat content.

### Second Example Notification

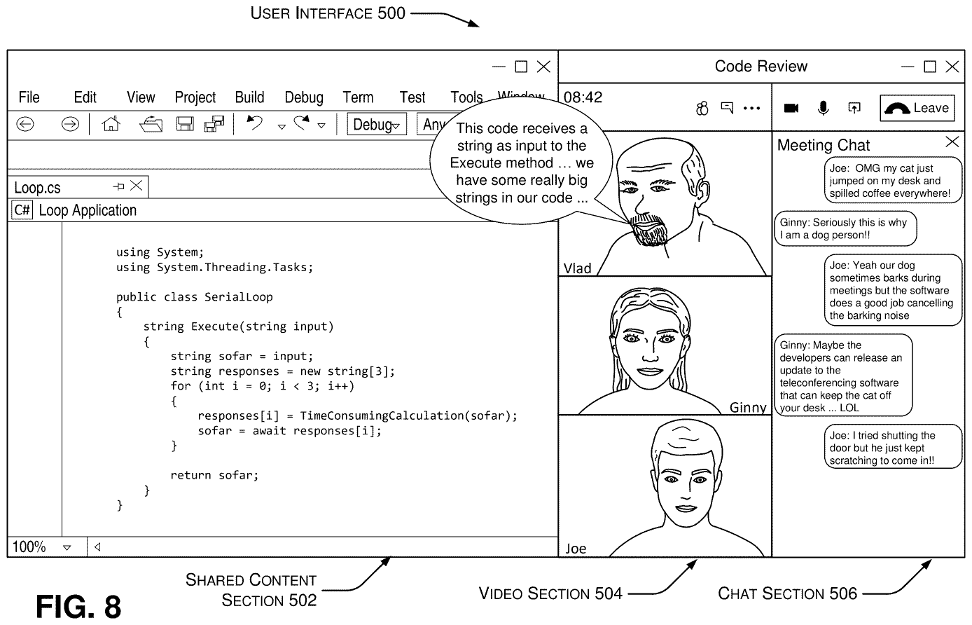

The following illustrates an example where a notification is output to Ginny and Joe to summarize content that Vlad is presenting while they are focused on chatting about another topic. FIG. 8 shows user interface 500 in a scenario where user Vlad is discussing an Execute method in the video section 504, note the Execute method is also shown in the shared content section 502 where the code is being shared by Vlad. Users Ginny and Joe are discussing pets in the chat section 506. Referring back to FIG. 4, an inference can be made in user attention inference 404 that Vlad's attention is directed to shared content section 502 because he is presenting content in that section to the other users. Conversely, an inference can be made that Ginny and Joe are focusing their attention on the chat section 506 at this time.

Presented content tracking 406 can track the content presented in the shared content section 502 and/or video section 504 by Vlad as well as the chat content entered by Ginny and Joe in the chat section 506. Time correlation 408 can correlate the presented content to a particular time period(s) during the teleconference. For instance, the time correlation can determine that the chat messages shown in FIG. 8 were entered during the time period when Vlad was discussing the Execute method. Content selection 410 can determine that the chat stream relates entirely to discussing pets during this time period, and that the audio-visual and shared content streams relate to the Execute method. In this case, the content selection can select the content discussed by Vlad so that Ginny and Joe can be notified of Vlad's discussion.

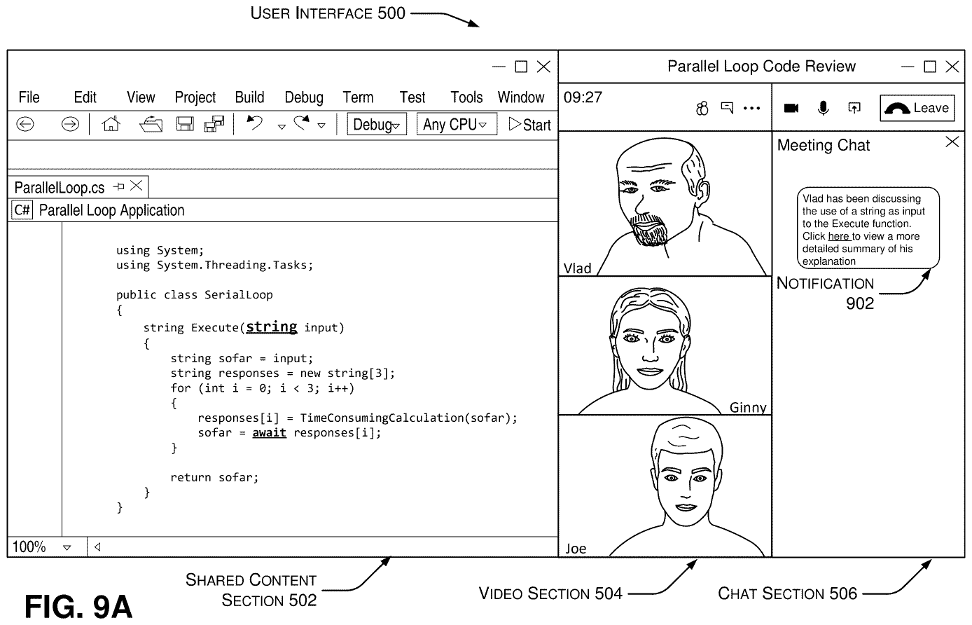

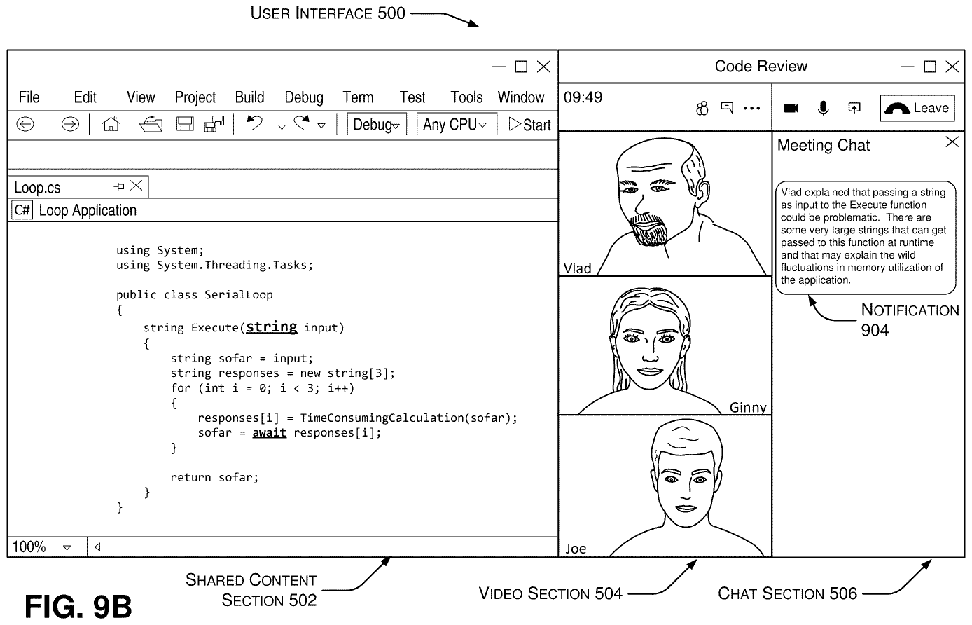

Notification 412 can output a notification to Ginny and/or Joe about the selected content. For instance, FIG. 9A shows a notification 902 where the chat section 506 is updated to indicate that Vlad has been discussing the Execute method. In some implementations, the notification includes a summary generated by a machine learning model. For instance, the summary can be generated by inputting the audio transcript into generative language model 100 (potentially with optically-recognized characters from the shared content section 502) and requesting that the generative language model summarize the audio transcript and/or optically-recognized characters In FIG. 9A, the generated summary states “Vlad has been discussing the use of a string as input to the Execute function.”

The notification 902 also includes a selectable link that allows Ginny and/or Joe to see a more detailed summary of the content presented by Vlad. FIG. 9B shows a scenario where chat section 506 has been updated with a notification 904 that conveys the more detailed summary of Vlad's discussion of the Execute method. In other cases, the link could take Ginny and/or Joe to text extracted from the audio stream during the time period when Ginny and Joe were chatting about pets, or to an audio-video recording that replays Vlad's discussion of the Execute method.

### Third Example Notification

In the examples discussed above, workflow 400 was performed to retroactively identify content that users may have missed during a teleconference. Then, the users were provided with a summary of that content after it had already been presented. In some implementations, however, users are notified in real-time when content is being presented in a particular teleconferencing data stream so that they can redirect their attention to that content. In other words, these implementations aim to prevent the user from missing the presented content in the first place.

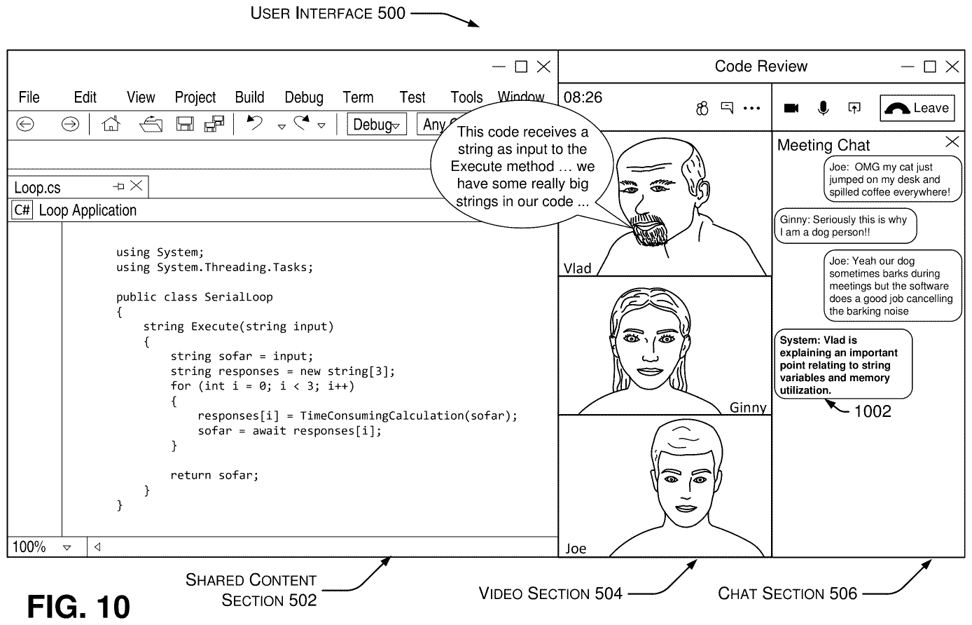

Referring back to FIG. 8, recall that Vlad is discussing an Execute method while Ginny and Joe are discussing pets. FIGS. 9A and 9B show how a notification can be retroactively provided to inform Ginny and Joe of the content that they may have missed. FIG. 10 shows an alternative approach where a notification 1002 is provided earlier in the discussion. The notification conveys that the Ginny and Joe may wish to focus on Vlad, who is presenting content in the shared content section 502. Notification 1002 can include a summary generated by a machine learning model of an ongoing topic of discussion by Vlad. For instance, notification 1002 can be triggered by a determination that the chat data stream has diverged from the audio-visual and/or shared content data streams.

Note that real-time notifications can also be provided without necessarily generating a summary. Instead, a notification can be output that merely indicates that users who are directing attention to one stream of content may wish to direct their attention to a different stream. In this manner, users can be redirected to different content streams during a teleconference without expending computational resources to generate summaries of potentially-missed content.

Also, note that in this case, the notification 1002 also includes a summary that shares context regarding Vlad's presentation. Thus, Ginny and Joe are not merely directed to Vlad's presentation, but also provided with some context to help them understand what is being presented when they shift their attention to the audio-visual stream.

### Example System

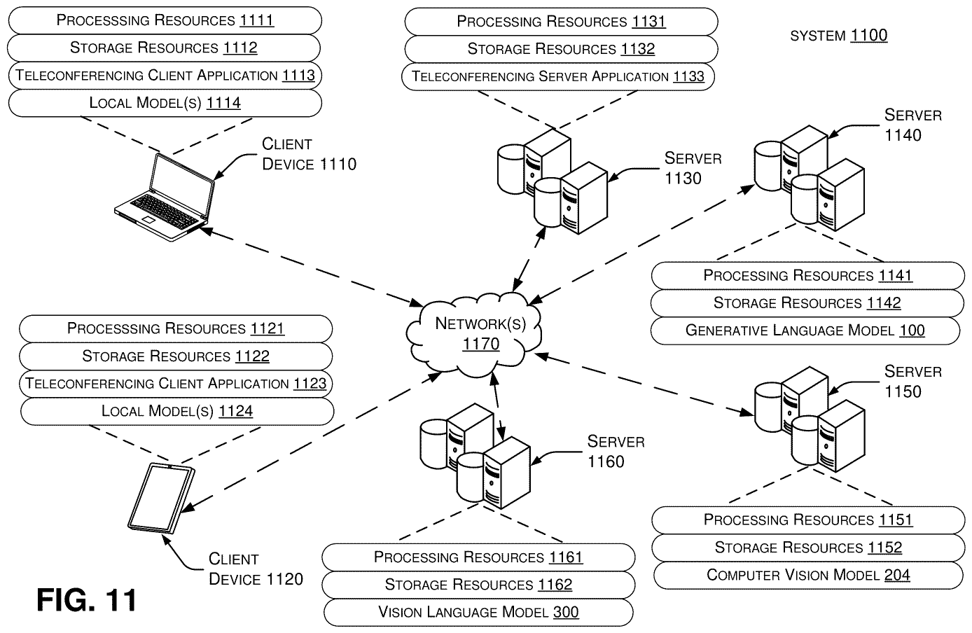

The present implementations can be performed in various scenarios on various devices. FIG. 11 shows an example system 1100 in which the present implementations can be employed, as discussed more below.

As shown in FIG. 11, system 1100 includes a client device 1110, a client device 1120, a server 1130, a server 1140, a server 1150, and a server 1160, connected by one or more network(s) 1170. Note that the client devices can be embodied as mobile devices such as smart phones or tablets, as well as stationary devices such as desktops, etc. Likewise, the servers can be implemented using various types of computing devices. In some cases, any of the devices shown in FIG. 11, but particularly the servers, can be implemented in data centers, server farms, etc.

Client device 1110 can have processing resources 1111 and storage resources 1112, client device 1120 can have processing resources 1121 and storage resources 1122, server 1130 can have processing resources 1131 and storage resources 1132, server 1140 can have processing resources 1141 and storage resources 1142, server 1150 can have processing resources 1151 and storage resources 1152, and server 1160 can have processing resources 1161 and storage resources 1162. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 1110 can include a teleconferencing client application 1113 and one or more local models 1114, and client device 1120 can include teleconferencing client application 1123 and one or more local models 1124. For instance, the teleconferencing client applications can provide a graphical interface such as user interface 500. The teleconferencing client applications can provide functionality for allowing users of the client devices to conduct audio/video teleconferencing with one another. For instance, the teleconferencing client applications can obtain a local video feed from a camera, audio from a microphone, local content (e.g., screen sharing) from an operating system, chat input from a keyboard, etc. The teleconferencing client applications can also interact with individual local models on their respective client devices as well as remote models hosted on one or more servers, as discussed more below.

Server 1130 can host teleconferencing server application 1133. The teleconferencing server application can coordinate teleconferences among the various other devices by communicating with the respective instances of the teleconferencing client application over network(s) 1170. For instance, the teleconferencing server application can perform audio enhancement of audio/video signals received from the client devices, e.g., noise suppression, echo removal, etc. The teleconferencing server application can also perform video enhancement, e.g., by sharpening a video signal, correcting low-light conditions, etc. The teleconferencing server application can also generate audio and/or video playback signals. For instance, the teleconferencing server application can select, synchronize, and/or mix selected microphone signals from the respective client devices. The teleconferencing server application can also mix video signals together with the audio signals and communicate the mixed video/audio signals to participants in a call as playback signals for playback by the teleconferencing client applications. The teleconferencing server application can also interact with any of the local models on the client devices as well as models hosted on one or more servers, as discussed more below.

Server 1140 can host generative language model 100, server 1150 can host computer vision model 204, and server 1160 can host vision language model 300. These models can output generated language, generated images, and/or generated computer vision results, respectively, in response to requests from the teleconferencing client applications and/or the teleconferencing server application. For instance, in some implementations, workflow 400 is implemented entirely on a client device by a local teleconferencing application that coordinates communications with one or more local or remote models. In other implementations, workflow 400 is implemented remotely from the client devices by the teleconferencing server application. In still further implementations, workflow 400 can be distributed with different portions of the workflow being performed by the teleconferencing client applications and the teleconferencing server application.

### Example Method

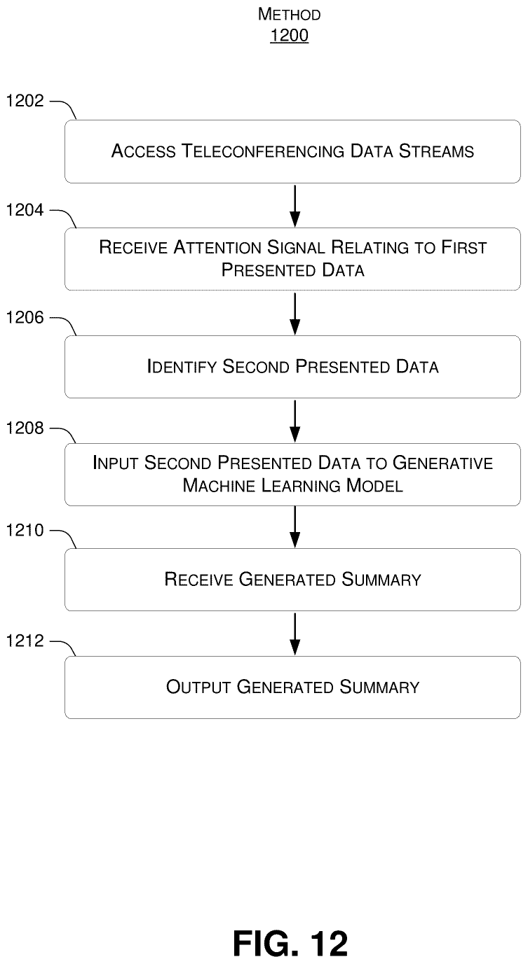

FIG. 12 illustrates an example computer-implemented method 1200, consistent with some implementations of the present concepts. Method 1200 can be implemented on many different types of devices, e.g., by one or more cloud servers, by a client device such as a laptop, tablet, or smartphone, or by combinations of one or more servers, client devices, etc.

Method 1200 begins at block 1202, where multiple teleconferencing data streams are accessed. For instance, the teleconferencing data streams can include an audio-visual stream, a shared content stream, a chat stream, etc.

Method 1200 continues at block 1204, where one or more attention signals are received. For instance, the one or more attention signals can convey that a particular participant directs their attention to first presented data from a first teleconferencing data stream during a particular time period.

Method 1200 continues at block 1206, where second presented data that was presented in a second teleconferencing data stream during the particular time period is identified. For instance, time correlation can be employed to determine when content presented in one data stream is presented concurrently (or at least temporally overlapping) with other content presented in another data stream.

Method 1200 continues at block 1208, where the second presented data is input to a machine learning model with a request to generate a summary of the second presented data. For instance, the second presented data can include text from chat, an audio transcript, and/or optically-recognized characters from a video feed or from shared content input, any or all of which can be input to a generative language model. In further implementations, the second presented data can also include images or video that are input to a computer vision model. Objects recognized by the computer vision model can be input to the generative language model to generate the summary.

Method 1200 continues at block 1210, where the generated summary is received from the machine learning model. In some cases, as in the examples shown above, the generated summary is in the form of text. In other cases, the generated summary can be provided using audio, video, etc.

Method 1200 continues at block 1212, where the generated summary is output. For instance, as shown above, the generated summary can be displayed on a graphical user interface via one or more graphical indicators, such as notification 702 in FIG. 7A, notification 902 in FIG. 9A, and notification 904 in FIG. 9B. For audio/video summaries, the generated summaries can be played back to a user during or after the teleconference. For instance, the generated summary can be output on an instance of a graphical user interface associated with a particular user, e.g., the participant corresponding to the attention signal received at block 1204.

In some cases, some or all of method 1200 is performed by a server. In other cases, some or all of method 1200 is performed on another device, e.g., a client device, or distributed across multiple devices.

### Additional Attention Signal Examples

The examples described above employ a few specific examples of attention signals to convey certain concepts. However, the disclosed concepts can be implemented in a wide range of scenarios using many different types of attention signals to adaptively present teleconferencing content. In addition, there are a wide range of techniques that can be employed to adaptively present teleconferencing content in addition to those already described above.

For example, in the specific examples presented above, the attention signals indicated that certain users were presenting shared content, presenting audio-visual content, or entering chat content at a specific time period during a teleconference. Thus, an inference was made that those users were directing their attention to the content with which they were actively presenting or entering into the teleconference. With respect to chat content specifically, some implementations may also consider the following as attention signals indicating the user is paying attention to the chat stream: the user enters an image, audio, video, other multimedia file to the chat stream, the user enters a link to the chat stream, the user reacts to a chat message (e.g., likes, loves, laughs, etc.), the user types a comment that they decide not to submit to the chat stream, etc.

In some cases, however, user attention can also be inferred from signals that indicate users are passively consuming content from a specific teleconferencing stream, without necessarily actively generating, entering, reacting to or presenting such content. For example, consider a user that hovers a cursor over the chat section during a teleconference but does not actually enter any content into the chat. As another example, consider two users looking at different portions of a chat window, e.g., one user has a different viewport of the chat than another. Here, the viewport can act as an attention signal that can provide insight into what content a user is paying attention to, because other content is not visible to that user. Assume that a first user has a view of the chat window that shows chat messages relating to the same subject matter that is being presented in the audio-visual or shared content streams, and a second user has a different view of the chat window that shows chat messages relating to subject matter. In this circumstance, some implementations may generate a summary of the audio-visual and shared content streams and present that summary to the second user but not the first user.

As another example of an attention signal, consider a user that has minimized a particular section of the user interface for a period of time. If a user has minimized the chat section, an inference can be made that the user is not paying attention to the chat content. This may be the case, for example, on a mobile device or other device with limited display area, e.g., if the local teleconferencing application does not show chat content concurrently with the audio-visual stream. As another example, if a user turns off (e.g., mutes) a speaker, an inference can be made that the user is not paying attention to the audio content presented for the period of time that the speaker is off.

As another example, some implementations can track user gaze. For instance, an eye tracking sensor can be employed to detect where a user is gazing at on a laptop screen. In a virtual or augmented reality setting, the eye tracking sensor can be combined with an Inertial Measurement Unit (IMU) that tracks a pose of the user's head to determine where the user's gaze is directed, potentially in a three-dimensional space where a three-dimensional immersive teleconference is occurring.

Note also that some implementations can employ a rules-based approach for inferring where a user's attention is directed. For instance, one rule could state that a user who enters at least a threshold number of keystrokes per minute into a chat is determined to be paying attention to the chat for as long as their moving average of keystrokes stays above the threshold. Another rule could state that as long as a user's gaze is directed to a specific content stream for at least 70% of a time period, the user is deemed to be paying attention to that content stream and not other content streams during that time period.

In other cases, rules-based or machine learning approaches can be employed to characterize user's attention based on multiple attention signals. For instance, if a user's gaze is largely directed to chat but the subject matter of their chat messages tends to follow content being presented via audio (e.g., using an audio transcript), a machine learning model (e.g., a support vector machine, neural network, decision tree, etc.) could be used to determine that the user is paying attention to the audio stream as well as the chat stream. As another example, if a user is presenting audio and video content but reads out one or chat messages during a particular time period, an inference could be made that this user is paying attention to the chat stream as well as their own presentation. For instance, in some implementations, a classifier can be employed where multiple attention signals as well as content from multiple streams is input to the classifier, and the classifier predicts whether the user's attention is directed to zero, one, or more of the content streams.

### Additional Content Selection Examples

In the examples discussed above, audio and/or chat content was summarized and adaptively presented to individual users during the course of an example teleconference. Many different alternative approaches can be employed. As one example, consider text displayed in the shared content section 502. In some cases, the local teleconferencing application may not have direct access to files shown in the shared content section. Instead, the local teleconferencing application may receive a bitmap of the user's screen, e.g., from the operating system. This bitmap can be processed using optical character recognition, and then the optically-recognized characters can be input to a generative machine learning model to determine/summarize the shared content section.

In other cases, however, the teleconferencing client or server applications can have access to the underlying files being shared. In this case, the information available is not limited to the specific portion of the file being shared on the screen. Instead, the entire file can be input to a generative machine learning model to obtain a summary of the content of the file, rather than just the portion of the file shown in the shared content section 502.

In addition, some implementations can correlate information across two or more teleconferencing data streams. One way to do this is to modify the presentation of objects in the shared content section 502 concurrently with presentation of a summary on the user interface 500. As shown in FIG. 9A, notification 902 summarizes Vlad's presentation in the audio-video stream while bolding and underlining the word “string” in the input argument to the Execute method. This is an example of how users can be informed of context from one teleconferencing data stream (the shared content stream) that helps them understand information presented in another teleconferencing data stream (the summary in the chat section). For example, the shared content stream and audio transcript can be input to a vision language model that recognizes the “string” keyword in the shared content section, and then the teleconferencing client or server application can modify the graphical user interface to emphasize this keyword.

As another example, consider a scenario where multiple objects are shown in the shared content section 502, e.g., a basketball, a dog, and a bicycle are all shown on a single slide. If the user presenting the shared content is speaking about the bicycle, then some implementations can draw the other users' attention to the bicycle, e.g., by drawing a box around the bicycle or otherwise visually emphasizing the bicycle. A similar approach can be employed if one or more users are chatting about the bicycle. One specific model that can be employed is Grounded SAM, described at Ren, et al., “Grounded SAM: Assembling open-world models for diverse visual tasks,” Jan. 25, 2024, arXiv preprint arXiv: 2401.14159. Grounded SAM can segment out objects based on received text inputs. Thus, some implementations can provide an object identifier from chat or audio content and then that object can be segmented out using Grounded SAM. The segmented area can be modified by the teleconferencing client or server application to emphasize that object in the video or shared content streams.

In addition, some implementations can augment one teleconferencing data stream with pertinent information from another stream, even if the subject matter in both streams has some overlap. For example, referring back to FIG. 8, assume that Vlad and Ginny are discussing memory utilization on the stack in their application instead of pets. However, assume that Ginny and Joe are not specifically discussing the Execute method being discussed by Vlad. However, by inputting content from both streams into a generative language model, the generative language model can infer that: (1) the Execute method uses stack memory for its input argument, (2) the string input argument can be very large, and (3) this relates to the problem being discussed by Ginny and Joe. In this case, a summary could be output to Ginny and Joe that says, “Vlad is currently discussing the Execute method, which can take some large string arguments as inputs and could cause high stack memory utilization.” This can be accomplished, for example, by prompting the generative language model to generate a summary of the audio transcript considering the chat transcript as additional context. In this manner, Ginny and Joe can be informed of the discussion by Vlad in the video section 504 in a manner that relates directly to their current topic of conversation in the chat section 506.

As a final point, during a teleconference, chat content often tends to lag the shared content and/or audio-visual content. In other words, users tend to chat about content after it is presented in the shared content section 502 or in video section 504. Thus, some implementations may perform time correlation by allowing the chat to “catch up” before inferring that chat users have missed out on content presented in other streams.

### Additional Notification Examples

As noted above, some implementations can trigger generation of a summary or other notification when various conditions are met. In the examples above, those conditions include: (1) a user's attention being directed to a particular teleconferencing data stream for a period of time, and (2) divergent subject matter being presented in another teleconferencing data stream during that period of time. In other implementations, summaries or other notifications could be presented according to other conditions. For instance, if there is a scheduled break in a teleconference, a summary or other notification could be presented at that time. As another example, summaries or other notifications can be presented when topics change, when presented content is superficial (e.g., jokes, introductions, etc.), when a user switches their attention from one stream to another, when one user explicitly requests an action item be performed by another user, etc. For instance, a machine learning model such as a generative language model or natural language understanding model (e.g., BERT-based) could be employed to detect topical changes in chat, audio, and/or optically-recognized characters from the shared content stream.

In the examples shown in the figures, notifications are implemented using graphical user interface elements that are displayed within one or more of the sections of user interface 500. As one example, pop-up windows can be employed to implement notifications, where the pop-up windows are overlaid on top of the user interface and are removed either after being displayed temporarily for a period of time, or in response to explicit user input to close the pop-up window. As another example, notifications can be implemented as callouts associated with a specific item of displayed content. For instance, referring back to FIGS. 9A and 9B, notifications 902 and/or 904 can be displayed by anchoring them to the “string” parameter of the Execute method, since they pertain to this method. As another example, a toast notification can be employed that slides over the user interface temporarily and is automatically removed after a period of time. In still further implementations, chat notifications can be provided in a chat stream, e.g. FIG. 7B shows an automated chat agent (“system”) that injects a summary of missed content into the chat section 506.

As also noted above, some implementations can employ audio-visual summaries or notifications. For instance, a user that misses part of a discussion in the audio-visual stream could receive a link that, when selected, replays the missed part of the audio-visual stream. In other cases, the missed content can be input to a generative machine learning model to generate a textual summary of the missed audio-visual content, so that the currently-presented audio-visual content is not interrupted. In other implementations, the generated summary can be played back as audio content using text-to-speech processing.

Some implementations can also track references to earlier meeting content. For instance, if a user asks a question in a chat that was answered 20 minutes previously in the audio-video stream, that user can be provided with a link to the section of the audio-video stream where the question is answered. Alternatively, the user can be provided with a generated summary of the answer to the question.

As another example, if a user asks a question in the audio-video stream that was answered earlier in the chat, that user can be provided with a link that surfaces the segment of chat where the question was answered. A generative machine learning model can identify the answer, and the teleconferencing client or server application can then visually distinguish the answer, e.g., by showing the answer in bold or highlighted in the chat section.

Note that some implementations may operate within a single content stream. For instance, if a question is asked in a chat section 506 and that question was previously answered in the chat section, an answer to the question and/or link back to the previous answer can be output in the chat section. Likewise, a question asked in the audio-visual section can be answered in the audio-visual section, e.g., either with a text-based notification or an audio-visual replay of the answer.

### Recording Examples

The examples above convey how teleconferencing content can be adaptively presented during an ongoing teleconference. These techniques can be extended to recordings of teleconferences as follows. Note that the following assumes that all content streams are recorded and temporally aligned as they occurred during the meeting, but this assumption can be relaxed depending on the specific recording capabilities of a given teleconferencing application.

For instance, consider a scenario where a user asks a first question and a second question using the audio-video stream during a teleconference. Later, that user enters a chat message that indicates that they have learned the answer to the second question, but not the first. In some implementations, when that user is viewing a recording of the teleconference, the user can be notified of the answer to the first question but not the second. For instance, by inputting the chat and audio transcripts to a generative language model, the generative language model can determine that the user subsequently figured out the answer to the second question but not the first. This can be accomplished, e.g., by prompting the generative language model to identify any unresolved questions in the recorded content streams. The generative language model could determine that the user had two different questions but that the second question was resolved during the meeting. Thus, the recording can be augmented for that user with a notification that conveys the answer to the first question, but not the second.

More generally, different augmented recordings could be generated for different users. Inferences can be made about what users digested based on their comments during a meeting, their attention signals, etc. Thus, each user can have different augmented recordings that are augmented with notifications to convey content that their attention signals and/or spoken or chat input indicate that they may have missed.

### User Profiles

Different users may have different preferences, as a result of their jobs, education, experiences, neurodiversity factors, etc. Some users may tend to prefer to focus primarily on a single content stream, whereas others may prefer to shift their attention among multiple streams. For users who may prefer to shift attention among content streams, real-time notifications can be useful. Thus, in some implementations, the teleconferencing client or server applications can redirect such users' attention in real-time to different content streams, e.g., in response to detecting divergent content among content streams, changes in topic in a particular content stream, etc.

For users who may prefer to focus attention on a specific content stream, summaries in their preferred content stream may be more useful than real-time notifications suggesting that they pay attention to another content stream. Thus, in some implementations, the teleconferencing client or server applications can generate summaries for such users to notify them of missed content in other content streams, so that they can remain informed while focusing on their preferred content stream.

Further implementations can capture topical preferences of users, expertise, etc. and tailor the information presented to those users accordingly. For instance, consider one user that is a non-technical person and another user that is an experienced programmer, both of whom are paying attention to a chat stream while a technical discussion relating to dynamic memory allocation is ongoing in the audio-visual stream. A generative language model could be prompted to generate a relatively simple, non-technical summary of the discussion for the non-technical user, and a more comprehensive, deeply technical summary for the experienced programmer.

### Model Interactions

In some implementations, a multi-modal generative model, such as a vision language model, can be fed multiple data streams of a teleconference in real time. When a user's attention is directed to a particular content stream, the multi-modal generative model can be prompted to perform a comparison of the content in that stream to content from any of the other data streams. When the content diverges in subject matter, the multi-modal generative model can be prompted to generate summaries of any subject matter missing from one stream that is present in another. In some cases, the model can be explicitly requested to determine whether the subject matter of two or content streams diverges. In other cases, the model can be requested to determine the respective similarity of subject matter from two steams, and the subject matter of the streams can be characterized as diverging when the similarity is low (e.g., below a threshold).

In this manner, a multi-modal generative model can detect when video information and text information diverge, e.g., by analyzing the aligned text and video encodings derived from the content streams. This can be implemented by feeding the multi-modal generative model temporally-aligned instances of a chat transcript, audio transcript, and video feeds. Then, the multi-modal generative model can be prompted using a prompt such as, “User 1 was focused on the chat stream from 4:57 through 5:24. What did they miss in the audio-video and/or shared content sections?” In this manner, the multi-modal generative model can generate a customized, context-sensitive summary for that user that covers the information presented in any stream that the user was not paying attention to for a period of time.

In other cases, smaller machine learning models can be employed to detect topical shifts in different streams. Then, when content diverges and a user's attention is directed to one stream, the content from the diverging stream can be provided to a larger, remote model for summarization. This can be implemented by having the teleconferencing client applications call the smaller local models to detect the topic shifts and then invoke the larger remote models to perform summary generation when a topic shift is detected.

### Technical Effect

As noted above, some users have difficulty paying attention to multiple incoming streams of teleconferencing data. While users can scroll back through a chat stream or wait for an audio-visual recording to be available to revisit any information they may have missed, this is time-consuming and impractical. The disclosed techniques offer an improved computer-user interaction by mitigating circumstances where the user has to provide inputs to explicitly revisit previously-presented content. Instead, by either summarizing previously-presented content or redirecting the user to a different content stream in real time, the disclosed techniques can allow the user to remain informed about an ongoing teleconference without requiring the user to provide input to request previously-presented content.

Furthermore, the use of attention signals to determine when to summarize content can provide efficient model utilization. While it is possible to input the entirety of every available content stream into a multi-modal model during an ongoing conference, this could result in significant processor, memory, and/or network utilization, particularly for large models residing on a remote server. By using attention signals to determine which content to summarize with a given model, a far smaller subset of teleconferencing content is input to the model. As a consequence, significant savings of processor, memory, and network bandwidth can be achieved.

Furthermore, as noted above, some implementations may employ relatively smaller local models to infer topic changes or salient points in a discussion. By limiting calls to larger server-based models to instances where smaller local models detect topic changes, action items, questions, divergent subject matter in different content streams, or other salient points in a teleconference, additional savings of processor, memory, and network bandwidth can also be achieved.

### Device Implementations

As noted above with respect to FIG. 11, system 1100 includes several devices, including a client device 1110, a client device 1120, a server 1130, a server 1140, a server 1150, and a server 1160. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 1170. Without limitation, network(s) 1170 can include one or more local area networks (LANs), wide area networks (WANs), the Internet, and the like.

### Additional Examples

Various examples are described above. Additional examples are described below. One example includes a computer-implemented method comprising accessing multiple teleconferencing data streams relating to a teleconference having multiple participants, receiving an attention signal indicating that a particular participant in the teleconference has directed attention to first presented data from a first teleconferencing data stream of the teleconference during a particular time period, identifying second presented data that was presented in a second teleconferencing data stream during the particular time period, inputting the second presented data to a generative machine learning model with a request to generate a summary of the second presented data, receiving a generated summary of the second presented data from the generative machine learning model, and outputting the generated summary of the second presented data to the particular participant.

Another example can include any of the above and/or below examples where the generated summary of the second presented data is output in the first teleconferencing data stream as a least one of a popup, a callout, a toast, or a chat message from an automated agent.

Another example can include any of the above and/or below examples where the generated summary of the second presented data is output by playing audio content in the second teleconferencing data stream.

Another example can include any of the above and/or below examples where the multiple teleconferencing data streams include an audio-video data stream, a chat data stream, and a shared content data stream.

Another example can include any of the above and/or below examples where the first teleconferencing data stream is the chat data stream, and the attention signal indicates that the particular participant entered text to the chat data stream during the particular time period.

Another example can include any of the above and/or below examples where the first teleconferencing data stream is the audio-video data stream, and the attention signal indicates that the particular participant was speaking during the particular time period.

Another example can include any of the above and/or below examples where the first teleconferencing data stream is the shared content stream, and the attention signal indicates that the participant was sharing content in the shared content stream during the particular time period.

Another example can include any of the above and/or below examples where the method further comprises determining whether to generate the summary based at least on a comparison of the first presented data to the second presented data.

Another example can include any of the above and/or below examples where the method further comprises determining whether second subject matter of the second presented data diverges from first subject matter of the first presented data using the generative machine learning model or another machine learning model and generating the summary in response to determining that the second subject matter diverges from the first subject matter.

Another example includes a system comprising a processor and a storage medium storing instructions which, when executed by the processor, cause the system to access multiple teleconferencing data streams relating to a teleconference having multiple participants, receive an attention signal indicating that a particular participant in the teleconference has directed attention to first presented data from a first teleconferencing data stream of the teleconference during a particular time period, identify second presented data that was presented in a second teleconferencing data stream during the particular time period, input the second presented data to a generative machine learning model with a request to generate a summary of the second presented data, receive a generated summary of the second presented data from the generative machine learning model, and output the generated summary of the second presented data to the particular participant.

Another example can include any of the above and/or below examples where the attention signal indicates that the particular participant gazed at the first presented data during the particular time period.

Another example can include any of the above and/or below examples where the attention signal is received from at least one of an eye tracking sensor or an inertial measurement unit

Another example can include any of the above and/or below examples where the attention signal indicates that the first presented data was visible to the particular participant during the particular time period.

Another example can include any of the above and/or below examples where the attention signal indicates that the second presented data was not visible to the particular participant during the particular time period.

Another example can include any of the above and/or below examples where the attention signal indicates whether a particular input device or a particular output device was active during the particular time period.

Another example can include any of the above and/or. below examples where the instructions, when executed by the processor, cause the system to perform optical character recognition on the second presented data, the generated summary being based at least in part on one or more optically-recognized characters from the second presented data

Another example can include any of the above and/or below examples where the instructions, when executed by the processor, cause the system to input an image or video from the second presented data to a computer vision model, the generated summary being based on one or more objects recognized in the second presented data by the computer vision model.

Another example can include any of the above and/or below examples where the first presented data or the second presented data includes images or video in a three-dimensional space, and the attention signal indicates a direction where the particular participant gazed in the three-dimensional space during the particular time period.

Another example can include any of the above and/or below examples where the instructions, when executed by the processor, cause the system to prompt the particular participant to direct their attention to the second teleconferencing data stream at a specific time.

Another example includes a computer-readable storage medium storing instructions which, when executed by a processing device, cause the processing device to perform acts comprising accessing multiple teleconferencing data streams relating to a teleconference having multiple participants, receiving an attention signal indicating that a particular participant in the teleconference has directed attention to first presented data from a first teleconferencing data stream of the teleconference during a particular time period, identifying second presented data that was presented in a second teleconferencing data stream during the particular time period, inputting the second presented data to a generative machine learning model with a request to generate a summary of the second presented data, receiving a generated summary of the second presented data from the generative machine learning model, and outputting the generated summary of the second presented data to the particular participant.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
accessing multiple teleconferencing data streams relating to a teleconference having multiple participants;
receiving an attention signal indicating that a particular participant in the teleconference has directed attention to first presented data from a first teleconferencing data stream of the teleconference during a particular time period;
identifying second presented data that was presented in a second teleconferencing data stream during the particular time period;
inputting the second presented data to a generative machine learning model with a request to generate a summary of the second presented data;
receiving a generated summary of the second presented data from the generative machine learning model; and
outputting the generated summary of the second presented data to the particular participant.

2. The computer-implemented method of claim 1, wherein the generated summary of the second presented data is output in the first teleconferencing data stream as a least one of a popup, a callout, a toast, or a chat message from an automated agent.

3. The computer-implemented method of claim 1, wherein the generated summary of the second presented data is output by playing audio content in the second teleconferencing data stream.

4. The computer-implemented method of claim 1, the multiple teleconferencing data streams including an audio-video data stream, a chat data stream, and a shared content data stream.

5. The computer-implemented method of claim 4, wherein the first teleconferencing data stream is the chat data stream, and the attention signal indicates that the particular participant entered text to the chat data stream during the particular time period.

6. The computer-implemented method of claim 4, wherein the first teleconferencing data stream is the audio-video data stream, and the attention signal indicates that the particular participant was speaking during the particular time period.

7. The computer-implemented method of claim 4, wherein the first teleconferencing data stream is the shared content stream, and the attention signal indicates that the participant was sharing content in the shared content stream during the particular time period.

8. The computer-implemented method of claim 1, further comprising:
determining whether to generate the summary based at least on a comparison of the first presented data to the second presented data.

9. The computer-implemented method of claim 8, further comprising:
determining whether second subject matter of the second presented data diverges from first subject matter of the first presented data using the generative machine learning model or another machine learning model; and
generating the summary in response to determining that the second subject matter diverges from the first subject matter.

10. A system comprising:
a processor; and
a storage medium storing instructions which, when executed by the processor, cause the system to:
access multiple teleconferencing data streams relating to a teleconference having multiple participants;
receive an attention signal indicating that a particular participant in the teleconference has directed attention to first presented data from a first teleconferencing data stream of the teleconference during a particular time period;
identify second presented data that was presented in a second teleconferencing data stream during the particular time period;
input the second presented data to a generative machine learning model with a request to generate a summary of the second presented data;
receive a generated summary of the second presented data from the generative machine learning model; and
output the generated summary of the second presented data to the particular participant.

11. The system of claim 10, wherein the attention signal indicates that the particular participant gazed at the first presented data during the particular time period.

12. The system of claim 11, the attention signal being received from at least one of an eye tracking sensor or an inertial measurement unit.

13. The system of claim 10, wherein the attention signal indicates that the first presented data was visible to the particular participant during the particular time period.

14. The system of claim 10, the attention signal indicating that the second presented data was not visible to the particular participant during the particular time period.

15. The system of claim 10, the attention signal indicating whether a particular input device or a particular output device was active during the particular time period.

16. The system of claim 10, wherein the instructions, when executed by the processor, cause the system to:
perform optical character recognition on the second presented data,
the generated summary being based at least in part on one or more optically-recognized characters from the second presented data.

17. The system of claim 10, wherein the instructions, when executed by the processor, cause the system to:
input an image or video from the second presented data to a computer vision model,
the generated summary being based on one or more objects recognized in the second presented data by the computer vision model.

18. The system of claim 10, wherein the first presented data or the second presented data includes images or video in a three-dimensional space, and the attention signal indicates a direction where the particular participant gazed in the three-dimensional space during the particular time period.

19. The system of claim 10, wherein the instructions, when executed by the processor, cause the system to:
prompt the particular participant to direct their attention to the second teleconferencing data stream at a specific time.

20. A computer-readable storage medium storing instructions which, when executed by a processing device, cause the processing device to perform acts comprising:
accessing multiple teleconferencing data streams relating to a teleconference having multiple participants;
receiving an attention signal indicating that a particular participant in the teleconference has directed attention to first presented data from a first teleconferencing data stream of the teleconference during a particular time period;
identifying second presented data that was presented in a second teleconferencing data stream during the particular time period;
inputting the second presented data to a generative machine learning model with a request to generate a summary of the second presented data;
receiving a generated summary of the second presented data from the generative machine learning model; and
outputting the generated summary of the second presented data to the particular participant.
